(19) United States
(12) Patent Application Publication
(10) Pub. No.: US 2026/0145373 A1
(43) Pub. Date: May 28, 2026

(54) INJECTION COMPRESSION MOLDING DEVICE

(71) Applicants: Hyundai Motor Company, Seoul (KR); Kia Corporation, Seoul (KR)

(72) Inventor: Jun Sik Choi, Hwaseong (KR)

(21) Appl. No.: 19/250,925

(22) Filed: Jun. 26, 2025

(30) Foreign Application Priority Data
Nov. 25, 2024 (KR) 10-2024-0169728

(51) Int. Cl. B29C 45/56; B29C 45/76

(52) U.S. Cl. CPC B29C 45/561; B29C 45/76

(57) ABSTRACT

An injection compression molding device includes a first mold configured to compress a molding resin, a second mold facing the first mold, and a height adjustment device located inside the second mold, the height adjustment device including an inclined surface having an outer surface opened in a direction in which the first mold is separated from the second mold, where at least a part of the height adjustment device is selectively joined to the first mold to form a cavity located between the first mold, an upper surface of the second mold, and the height adjustment device.

### CROSS-REFERENCE TO RELATED APPLICATION

This application claims under 35 U.S.C. § 119(a) the benefit of Korean Patent Application No. 10-2024-0169728, filed on Nov. 25, 2024, the entire contents of which are incorporated herein by reference.

### BACKGROUND

### (a) Technical Field

The present disclosure relates to an injection compression molding device, more particularly, to the injection compression molding device configured to uniformly control, through a height adjustment device, pressure of a molded product during a molding process so as to avoid defects that may occur in a conventional molding process and to improve the quality of the molded product.

### (b) Description of the Related Art

In an injection compression molding technique of the related art, a vertical joining method is mainly used. In the vertical joining method, a first mold and a second mold are vertically joined to each other so as to produce a molded product. Such a method may maintain structural stability of a molded product by applying a constant pressure to a high-temperature molded product and may ensure relatively reliable quality for a molded product having a simple shape. The vertical joining method has been widely used because this method is suitable to maintain a constant thickness of a molded product and a simple structure thereof.

However, the vertical joining method of the related art has several problems. First, there is a problem in that contact portions of molds are deformed when the molds are vertically joined to each other at a high temperature. Accordingly, deformation of the contact portions causes deterioration in quality of a molded product. Further, such deformation is particularly noticeable in a molded product having a complex shape. In addition, when horizontal jointing is required, a separate component is added, resulting in a complex mold structure. Further, in this case, it take longer time to perform a process of extracting the molded product from the molds, causing deterioration in process efficiency.

In order to address the above-described problems of the related art, research and development has been actively conducted to improve a mold joining method and increase efficiency of a molding process.

It would be desirable to provide a technique for improving a joining method of molds in an injection compression molding process.

The above information disclosed in this Background section is only for enhancement of understanding of the background of the disclosure, and therefore it may contain information that does not form the prior art that is already known in this country to a person of ordinary skill in the art.

### SUMMARY

The present disclosure provides an injection compression molding device capable of preventing mold deformation that occurs when molds are vertically joined to each other and simplifying a mold structure, thereby increasing efficiency of a molding process. Another object of the present disclosure is to improve productivity by facilitating extraction of a molded product through a height adjustment device, and to enable horizontal joining of molds without additional components.

The objects of the present disclosure are not limited to the above-mentioned objects, and other technical objects not mentioned herein will be clearly understood by those skilled in the art to which the present disclosure pertains from the detailed description of the embodiments.

According to the present disclosure, an injection compression molding device includes: a first mold configured to compress a molding resin; a second mold facing the first mold; and a height adjustment device located inside the second mold, the height adjustment device configured to open in a direction in which the first mold is separated from the second mold, wherein at least a part of the height adjustment device is selectively joined to the first mold so as to form a cavity located between the first mold, the second mold, and the height adjustment device.

In one aspect, the present disclosure provides an injection compression molding device including a first mold configured to compress a molding resin, a second mold facing the first mold, and a height adjustment device located inside the second mold, the height adjustment device including an inclined surface having an outer surface opened in a direction in which the first mold is separated from the second mold, wherein at least a part of the height adjustment device is selectively joined to the first mold so as to form a cavity located between the first mold, an upper surface of the second mold, and the height adjustment device.

In a preferred embodiment, the injection compression molding device may further include a hole formed in the second mold, the hole gradually expanding in the direction in which the first mold is separated from the second mold, wherein the height adjustment device may include at least one guide block located in the hole, a guide part coupled to a lower end of the guide block, the guide part being configured to move the guide block upwards and downwards, and a cooling hose coupled to the guide block, the cooling hose being adjacent to the guide part.

In another preferred embodiment, the injection compression molding device may further include a stepped portion located on the second mold, the stepped portion facing the guide block, and a protrusion located on the guide block, the protrusion extending horizontally relative to the stepped portion.

In still another preferred embodiment, the guide part may include a guide bar coupled to the lower end of the guide block, and a housing located at a lower end of the guide bar.

In yet another preferred embodiment, the injection compression molding device may further include a guide support plate located at a lower end of the housing, a fixing bolt connecting the guide support plate to the housing, wherein the housing may include a fluid inlet configured to allow gas to be introduced therethrough.

According to the present disclosure, an injection molding method includes: moving, by a controller, a guide block upwards along an inclined surface of a second mold by introducing gas in a direction in which the first mold is separated from the second mold; moving, by the controller, the first mold in a direction facing the guide block such that a surface of the first mold and a surface of the guide block contact each other; injecting, by the controller, a molding resin into a cavity formed between the first mold, the second mold, and the guide block; compressing, by the controller, the molding resin injected into the cavity by the first mold; and moving, by the controller, the first mold in a direction away from the second mold, cooling a product, and extracting the product.

In another aspect, the present disclosure provides an injection compression molding method including moving, in a state in which compression force of a first mold is removed, a guide block upwards along an inclined surface of a second mold by introduced gas in a direction in which the first mold is separated from the second mold, moving the first mold in a direction facing the guide block such that a surface of the first mold and a surface of the guide block contact each other, injecting, in a state in which the surfaces of the first mold and the guide block contact each other, a molding resin into a cavity formed between the first mold, an upper surface of the second mold, and the guide block, compressing the molding resin injected into the cavity by the first mold, and moving the first mold in a direction away from the second mold, cooling a product, and extracting the product.

In a preferred embodiment, the upward movement of the guide block along the inclined surface of the second mold by the introduced gas in the state in which the compression force of the first mold is removed may include receiving, by a controller, a position of the guide block from an input part and determining, by the controller, whether the guide block is moved by a predetermined length, and moving, by the controller, the first mold in a direction toward the second mold when the guide block is moved by the predetermined length.

In another preferred embodiment, the injection of the molding resin into the cavity formed when the surfaces of the first mold and the guide block contact each other may include receiving, by the controller, whether the surfaces of the first mold and the guide block contact each other from the input part and determining, by the controller, whether the surfaces of the first mold and the guide block contact each other, and injecting, by the controller, a part of the molding resin into the cavity when the surfaces of the first mold and the guide block contact each other.

In still another preferred embodiment, the compression of the molding resin injected into the cavity by the first mold may include moving the first mold in the direction toward the second mold so as to return the guide part moving the guide block upwards to an original position thereof, injecting the remaining molding resin into the cavity, and compressing the molding resin.

In yet another preferred embodiment, the movement of the first mold in the direction away from the second mold to cool and extract the product may include cooling the product produced after the first mold compresses the molding resin, moving the first mold in the direction away from the second mold, and extracting the product.

According to the present disclosure, a non-transitory computer readable medium containing program instructions executed by a processor includes: program instructions that move a guide block upwards along an inclined surface of a second mold by introducing gas in a direction in which the first mold is separated from the second mold; program instructions that move the first mold in a direction facing the guide block such that a surface of the first mold and a surface of the guide block contact each other; program instructions that inject a molding resin into a cavity formed between the first mold, the second mold, and the guide block; program instructions that compress the molding resin injected into the cavity by the first mold; and program instructions that move the first mold in a direction away from the second mold, cooling a product, and extracting the product.

Other aspects and preferred embodiments of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a perspective view of an injection compression molding device according to an embodiment of the present disclosure;

FIGS. 2A to 2C are perspective views of a height adjustment device and enlarged views of a part of the height adjustment device, according to the embodiment of the present disclosure;

FIGS. 3A to 3C are views each showing an injection compression molding process according to the embodiment of the present disclosure;

FIG. 4 is a schematic flowchart of an injection compression molding step according to the embodiment of the present disclosure; and

FIG. 5 is a specific flowchart of the injection compression molding step according to the embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, reference will be made in detail to various embodiments of the present disclosure, examples of which are illustrated in the accompanying drawings and described below. While the disclosure will be described in conjunction with exemplary embodiments, it will be understood that the present description is not intended to limit the disclosure to the exemplary embodiments. On the contrary, the disclosure is intended to cover not only the exemplary embodiments, but also various alternatives, modifications, equivalents, and other embodiments, which may be included within the spirit and scope of the disclosure as defined by the appended claims. The present embodiments are provided to more fully explain the disclosure to those of ordinary knowledge in the art.

Terms such as “part” and “unit” described in the specification mean a unit configured to process at least two functions or operations, and the unit may be implemented by hardware or software or a combination of hardware and software.

The terms used in the specification are merely used to describe specific embodiments and are not intended to limit the embodiments. Singular forms are intended to include plural forms as well, unless the context clearly indicates otherwise.

Moreover, a controller 500 may be implemented by an algorithm configured to control the operation of various components, e.g., disposed in a vehicle, a memory configured to store data constituting a program that reproduces the algorithm, and a processor configured to perform the above-described operation using data stored in the memory. In this case, the memory and the processor may be implemented as separate chips. Alternatively, the memory and the processor may be implemented as a single chip. For example, the controller 500 may include at least two of an electronic control unit (ECU), a central processing unit (CPU), a microprocessor unit (MPU), a microcontroller unit (MCU), an application processor (AP), or any type of processor well known in the technical field of the present disclosure.

Furthermore, the controller 500 may be formed of a combination of software and hardware capable of performing an operation on at least two applications or programs for executing a method according to embodiments of the present disclosure.

Hereinafter, embodiments will be described in detail with reference to the accompanying drawings. In describing the embodiments with reference to the accompanying drawings, the same or corresponding components will be denoted by the same reference numerals and redundant description thereof will be omitted.

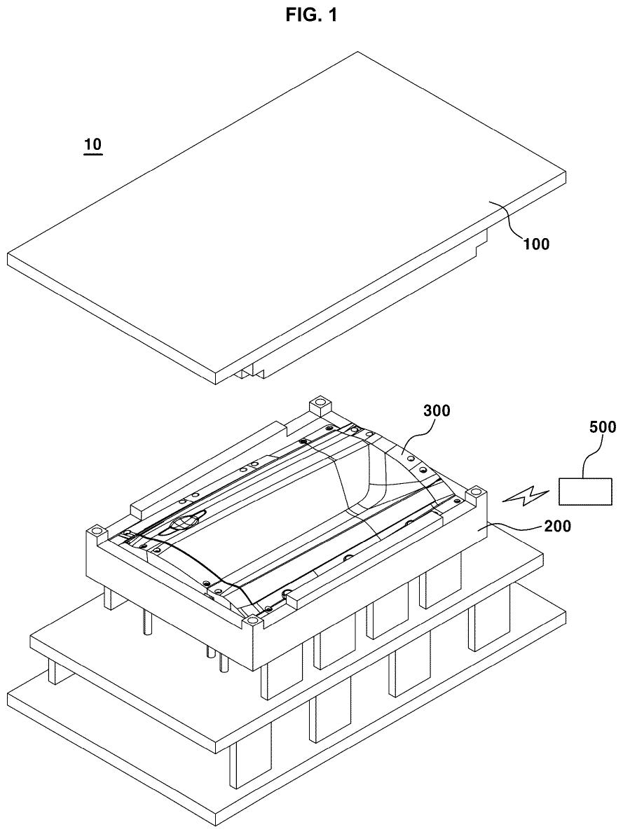

FIG. 1 is a perspective view of an injection compression molding device 10.

According to an embodiment of the present disclosure, the injection compression molding device 10 is comprised of a first mold 100 configured to compress a molding resin, a second mold 200 facing the first mold 100, and a height adjustment device 300 located inside the second mold 200, in which the height adjustment device includes an inclined surface 313, at least a part of the outer surface of which is opened in a direction in which the first mold 100 is separated from the second mold 200.

The first mold 100 is located on the upper portion of the injection compression molding device 10 and is configured to have a structure vertically corresponding to the second mold 200. In addition, the first mold 100 is configured to include an injection part 110 through which the molding resin is injected toward the second mold 200. The injection part 110 is a passage through which the molding resin is injected and is formed to pass through the inside of the first mold 100.

The injection part 110 may be disposed at the center of the first mold 100 and may extend toward the second mold 200 in a state of passing through the inside of the first mold 100. In another embodiment, at least two injection parts 110 may be arranged with a predetermined interval therebetween in a state of passing through the inside of the first mold 100.

The second mold 200 facing the first mold 100 is located at the lower portion of the injection compression molding device 10. The uppermost surface of the second mold 200 is spaced apart from the injection part 110 of the first mold 100 in a state of facing the injection part. Additionally, the second mold 200 has a hole 210 formed therein and configured to surround the uppermost surface of the second mold 200. The hole 210 has a cross-sectional area gradually increasing in a direction in which the first mold 100 is separated from the second mold 200.

The hole 210 has the height adjustment device 300 mounted therein, and the height adjustment device 300 mounted in the hole 210 is configured to surround the upper surface of the second mold 200.

The height adjustment device 300 is formed of at least one guide block 310 selectively coming into contact with the first mold 100, a guide part 320 coupled to the lower end of the guide block 310 and for moving the guide block 310 upwards and downwards, and a cooling hose 330 that is adjacent to the guide part 320 and is coupled to the lower end of the guide block 310.

The guide block 310 is located at the upper portion of the height adjustment device 300, and the upper surface of the guide block 310 is configured to selectively contact the lower surface of the first mold 100 through upward-and-downward movement of the guide part 320.

In addition, the guide block 310 has the inclined surface 313 on the outer surface thereof. The inclined surface 313 extends from the lower end of the guide block 310 to the upper end of the guide block 310 and has a predetermined angle relative to the height direction of the guide block 310. Specifically, the inclined surface 313 is formed to be gradually inclined outwards from the lower end of the guide block 310 to the upper end of the guide block 310.

The guide block 310 is moved upwards and downwards in the height direction of the hole 210 by the guide part 320. The upper end of the guide part 320 configured to move the guide block 310 upwards and downwards in the height direction is in contact with the lower end of the guide block 310. Here, the height direction refers to the upward-and-downward direction in which the second mold 200 is engaged with the first mold 100.

The guide part 320 is comprised of a guide bar 321 in contact with the lower end of the guide block 310 and a housing 322 surrounding the lower end of the guide bar 321.

The housing 322 includes a fluid inlet 323 through which gas is introduced, and the fluid inlet 323 may be located at the lower end of the housing 322. The gas introduced through the fluid inlet 323 generates gas pressure inside the housing 322.

The guide bar 321 located at the upper end of the housing 322 is moved upwards in the height direction by the gas pressure inside the housing 322 generated by the introduced gas. In this case, the guide block 310 in contact with the surface of the guide bar 321 is moved upwards integrally with the guide bar 321. When the guide block 310 is moved upwards, the upper surface of the guide block 310 is located closer to the first mold 100 than to the upper surface of the second mold 200.

When the upper surface of the guide block 310 is in contact with the surface of the first mold 100 through upward movement of the guide bar 321, a cavity 400 located between the first mold 100, the second mold 200, and the guide block 310 is sealed. The cavity 400 refers to a space into which a molding resin is introduced through the injection part 110 of the first mold 100 and is selectively opened and closed by the first mold 100 and the guide block 310.

Furthermore, when the first mold 100 is moved in a direction toward the second mold 200, the cavity 400 is compressed such that the volume thereof decreases. Conversely, when the first mold 100 is moved in a direction away from the second mold 200, the volume of the cavity 400 increases.

In addition, the guide block 310 may be moved downwards in a direction toward the second mold 200 by pressure of the first mold 100. Gas pressure is applied to the lower end of the guide bar 321 supporting the guide block 310, and compression force by the first mold 100 is applied to the upper end of the guide bar 321. When the compression force applied to the upper end of the guide bar 321 by the first mold 100 is greater than the gas pressure applied to the lower end of the guide bar 321, the guide bar 321 is moved downwards. In this case, the guide block 310 in contact with the surface of the guide bar 321 is also moved downwards by the compression force of the first mold 100.

When the guide block 310 is moved downwards, the guide block 310 faces a stepped portion 220 that is located in the second mold 200 and is adjacent to the inner surface of the guide block 310. The stepped portion 220 is located at at least a part of the hole 210 in the height direction.

In addition, the guide block 310 includes a protrusion 311 extending in the horizontal direction relative to the stepped portion 220. Preferably, the protrusion 311 is formed to extend in a direction toward the inner side of the second mold 200.

When the guide block 310 is moved downwards, the protrusion 311 located on the guide block 310 contacts the upper end of the stepped portion 220. Therefore, when the guide block 310 is moved downwards, a part of the guide block 310 faces the stepped portion 220, and the lower end of the protrusion 311 faces the upper end of the stepped portion 220. In this manner, the surface of the guide block 310 may contact the surface of the second mold 200.

The stepped portion 220 serves as a stopper having a function of restricting movement of the guide block 310. Accordingly, the guide block is not further moved toward the lower end of the hole 210 when the surface of the guide block 310 and the surface of the second mold 200 contact each other.

In order to prevent unnecessary movement of the guide part 320, which occurs during the upward-and-downward movement of the guide part 320, a guide support plate 340 is installed at the lower end of the housing 322. The guide support plate 340 is fastened to the lower end of the housing 322 by a fixing bolt 350.

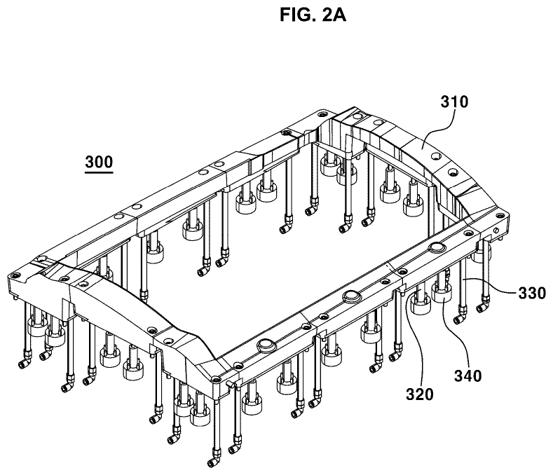

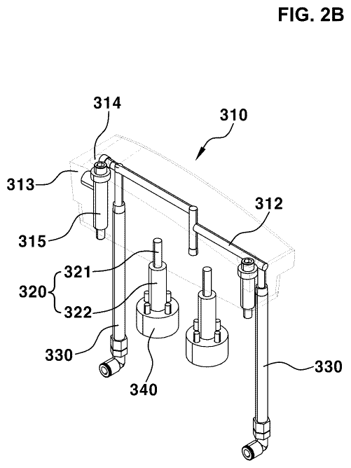

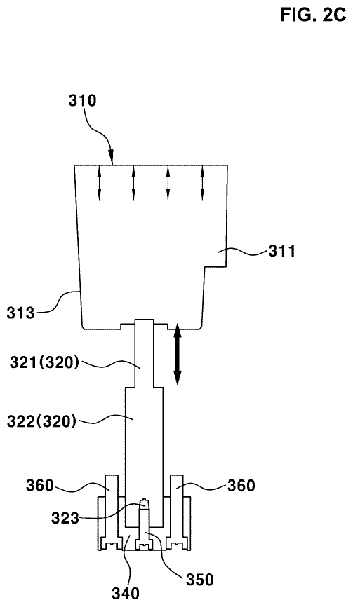

FIGS. 2A to 2C are perspective views of the height adjustment device 300 and enlarged views of a part of the height adjustment device 300.

According to the embodiment of the present disclosure, the height adjustment device 300 is comprised of at least one guide block 310. The guide part 320 and the cooling hose 330 are connected to the lower end of the guide block 310. Preferably, two guide parts 320 and two cooling hoses 330 may be coupled to the lower end of the guide block 310.

The cooling hoses 330 are located inside the guide block 310 and are fluidly connected to a cooling line 312 configured to cool an internal product. Preferably, coolant having a temperature of 25° C. or lower may be introduced into the cooling hoses 330 to cool a product molded at 60° C. to 80° C.

The upper surface of the guide block 310 is in contact with the surface of the first mold 100, and the shape of the upper surface of the guide block 310 may be manufactured to correspond to the shape of the lower surface of the first mold 100. Therefore, the upper surface of the guide block 310 may be formed to have a shape such as a curved surface, a flat surface, or a polygonal surface so as to correspond to the shape of the lower surface of the first mold 100.

The guide block 310, the upper surface of which is in contact with the surface of the first mold 100, is inserted into the hole 210 located in the second mold 200 and is configured to surround the upper surface of the second mold 200.

The process of inserting the height adjustment device 300 into the hole 210 located in the second mold 200 is described as follows.

First, the guide block 310 is inserted into the upper end of the hole 210. Here, the guide block 310 is inserted thereinto in a direction in which the first mold 100 is adjacent to the second mold 200.

After the guide block 310 is inserted into the upper end of the hole 210, the guide part 320 and the guide support plate 340 are inserted into the lower end of the hole 210. In this case, the guide part 320 and the guide support plate 340 are inserted thereinto in a direction in which the first mold 100 is separated from the second mold 200. The guide support plate 340 is in contact with the surface of a part of the second mold 200 adjacent to the lower end of the hole 210. Furthermore, the guide support plate 340 is fastened to the second mold 200 through a fastening bolt 360.

After the guide support plate 340 is fastened thereto, a fastening bolt 315 is inserted into a fastening hole 314 that extends from the upper surface of the guide block 310 to the lower surface of the guide block 310 and penetrates therethrough. The fastening bolt 315 is temporarily fastened to the second mold 200. When a user rotates the fastening bolt 315 clockwise based on the drawing, the guide block 310 is lowered from the upper end of the hole 210 to the lower end of the hole 210.

The guide block 310 is moved downwards from the upper end of the hole 210 to the lower end of the hole 210 and comes into surface contact with the guide bar 321. When the lower end of the guide block 310 and the upper end of the guide bar 321 contact each other, the user rotates the fastening bolt 315 counterclockwise. The fastening bolt 315 is continuously rotated counterclockwise and is separated from the guide block 310.

When the fastening bolt 315 is separated therefrom, the guide block 310 comes into surface contact with the guide bar 321. Accordingly, the guide block 310 is moved upwards and downwards integrally with the guide bar 321 according to upward-and-downward movement of the guide bar 321.

According to the embodiment of the present disclosure, the guide part 320 may be configured as a gas cylinder. The guide part 320 performs a function of moving the guide block 310 upwards and downwards and serves to buffer compression force that the guide block 310 receives from the first mold 100.

A description will be given as to the operation mechanism of the guide part 320. First, gas is introduced through the fluid inlet 323 located in the housing 322. When the gas is introduced therethrough, the introduced gas forms pressure inside the housing 322. The gas pressure formed inside the housing 322 is applied to the lower portion of the guide bar 321, thereby providing force to push the guide bar 321 upwards. In this case, the guide bar 321 is moved upwards in the height direction, and the guide block 310 in surface contact with the guide bar 321 is also moved upwards integrally with the guide bar 321.

After the guide block 310 is moved upwards, the first mold 100 is moved downwards in a direction toward the guide block 310. Through downward movement of the first mold 100, the lower surface of the first mold 100 and the upper surface of the guide block 310 contact each other.

In a state in which the lower surface of the first mold 100 and the upper surface of the guide block 310 contact each other, compression force applied from the first mold 100 to the guide block 310 is greater than internal gas pressure of the housing 322 that supports the guide block 310, the guide bar 321 is moved downwards in the height direction. Here, the guide block 310 in surface contact with the guide bar 321 is also moved downwards integrally with the guide bar 321.

During downward movement of the guide bar 321, gas pressure inside the housing 322 serves to buffer a part of the compression force applied from the first mold 100, thereby controlling the downward movement speed of the guide bar 321 and the guide block 310 and absorbing impact due to the compression force.

When compression force applied to the upper end of the guide bar 321 from the first mold 100 becomes smaller than gas pressure inside the housing 322 applied to the lower end of the guide bar 321, the guide bar 321 is moved upwards again and returns to the original position thereof. At this time, the guide block 310 is also moved upwards integrally with the guide bar 321.

According to another embodiment of the present disclosure, the guide part 320 may be configured as a hydraulic cylinder. When the guide part 320 is configured as a hydraulic cylinder, unlike the gas cylinder described above, hydraulic fluid is injected through the fluid inlet 323. Hydraulic fluid is injected therethrough to form hydraulic pressure inside the housing 322, and the lower end of the guide bar 321 is moved upwards by hydraulic pressure formed inside the housing 322.

On the other hand, when compression force applied to the upper end of the guide bar 321 from the first mold 100 is greater than internal hydraulic pressure of the housing 322, the guide bar 321 is moved downwards, and the guide block 310 in surface contact with the guide bar 321 is also moved downwards.

In another embodiment of the present disclosure, the guide part 320 may be configured as an elastic device. When the guide part 320 is configured as the elastic device, an elastic member (not shown) is located inside the housing 322, and the upper end of the elastic member (not shown) is connected to the lower end of the guide bar 321.

The elastic member (not shown) pushes the guide bar 321 upwards using restoring force from the compressed state. At this time, the guide bar 321 is moved upwards by restoring force of the elastic member (not shown), and the guide block 310 in surface contact with the guide bar 321 is also moved upwards integrally with the guide bar 321.

In contrast, when compression force applied to the upper end of the guide bar 321 from the first mold 100 is greater than restoring force of the elastic member (not shown) acting on the lower end of the guide bar 321, the guide bar 321 is moved downwards. During this process, the elastic member (not shown) is compressed again. The guide block 310 integrally connected to the guide bar 321 is also moved downwards by downward movement of the guide bar 321.

When compression force of the first mold 100 applied to the upper end of the guide bar 321 is smaller than restoring force of the elastic member (not shown) applied to the lower end of the guide bar 321, the guide bar 321 is moved upwards again by restoring force of the elastic member (not shown).

In this manner, the guide part 320 is configured in various forms to move the guide block 310 upwards or downwards in the height direction.

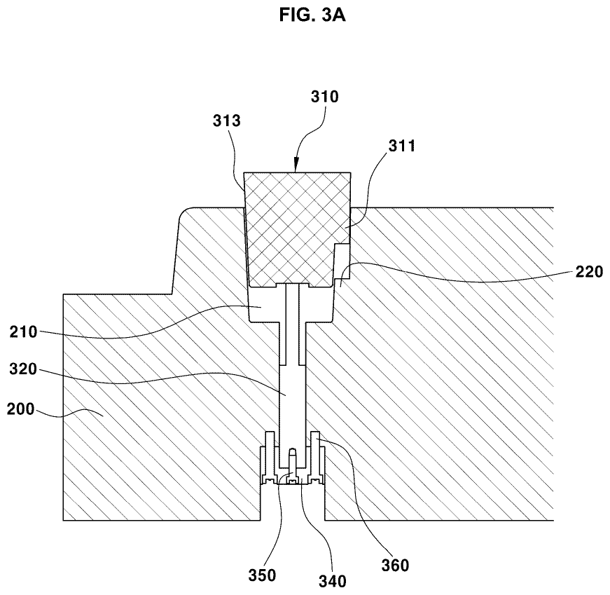

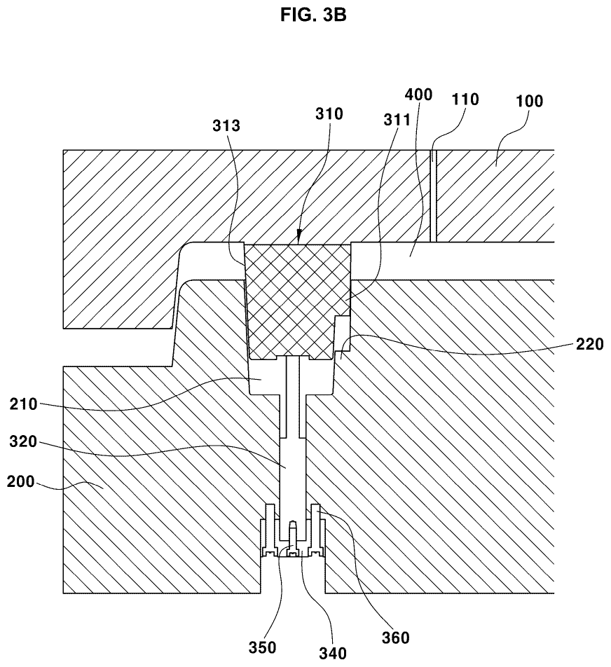

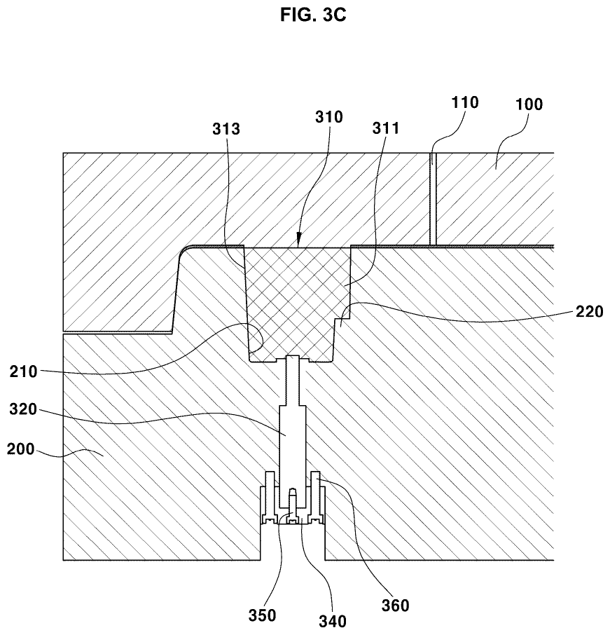

FIGS. 3A to 3C are views each showing an injection compression molding process according to the embodiment of the present disclosure.

FIG. 3A is a view showing the height adjustment device 300 before a molding resin is injected into the cavity 400 through the injection part 110 located in the first mold 100, and the guide bar 321 is moved upwards by internal gas pressure of the housing 322. In this case, since the guide block 310 is in surface contact with the guide bar 321, the guide block is moved upwards integrally with the guide bar 321.

When the guide block 310 is moved upwards, the upper surface of the guide block 310 is located closer to the first mold 100 than to the upper surface of the second mold 200. Therefore, when the first mold 100 is moved downwards in a direction toward the second mold 200, the lower surface of the first mold 100 comes into contact with the upper surface of the guide block 310.

After the guide block 310 is moved upwards, the first mold 100 is moved downwards in a direction toward the second mold 200.

FIG. 3B is a view showing a state of the injection compression molding device 10 during an injection process in which a molding resin is injected into the cavity 400. In this state, the upper surface of the guide block 310 and the lower surface of the first mold 100 face each other.

In addition, the upper surface of the guide block 310 and the lower surface of the first mold 100 contact each other, and at least one guide block 310 may be horizontally joined to the surface of the first mold 100.

Additionally, when the upper surface of the guide block 310 and the lower surface of the first mold 100 contact each other, the cavity 400 located between the lower surface of the first mold 100, the upper surface of the second mold 200, and the inner surface of the guide block 310 is sealed. When the cavity 400 is sealed, a molding resin is introduced into the cavity 400 through the injection part 110.

FIG. 3C is a view showing a state of the injection compression molding device 10 during a process of compressing the molding resin injected into the cavity 400. In this state, the guide block 310 is moved downwards by compression force applied from the first mold 100. Preferably, compression force of the first mold 100 is applied to the upper end of the guide bar 321 through the guide block 310, and the compression force applied to the upper end of the guide bar 321 is greater than gas pressure inside the housing 322 applied to the lower end of the guide bar 321. Accordingly, the guide bar 321 is moved downwards, and the guide block 310 is also moved downwards along the guide bar 321 by compression force of the first mold 100.

When the guide block 310 is moved downwards, the inner end of the guide block 310 comes into contact with the stepped portion 220 located in the second mold 200. That is, the inner end of the guide block 310 is inserted toward the lower end of the hole 210 along the stepped portion 220. When the guide block 310 is moved toward the lower end of the hole 210 along the stepped portion 220 such that the protrusion 311 of the guide block 310 comes into contact with the upper end of the stepped portion 220, downward movement of the guide block 310 is stopped.

In this manner, the first mold 100 is moved downwards in a direction toward the second mold 200 to compress the molding resin and move the guide block 310 downwards.

After compressing the molding resin, the first mold 100 is moved upwards again in the direction of being separated from the second mold 200. Here, external force applied via the first mold 100 is removed, and the guide bar 321 is moved upwards again by internal pressure of the housing 322 acting on the lower end of the guide bar 321.

At this time, the guide block 310 receiving upward force from the guide bar 321 is moved upwards along the inclined surface 313. In addition, the inclined surface 313 is formed to be gradually inclined in a direction in which the first mold 100 is separated from the second mold 200, thereby smoothly extracting a product made through compression of the molding resin.

When the first mold 100 is continuously moved upwards and is separated from the guide block 310 and the second mold 200, the cavity 400 is opened. When the cavity 400 is opened, the product completed through compression of the molding resin is extracted from the cavity 400.

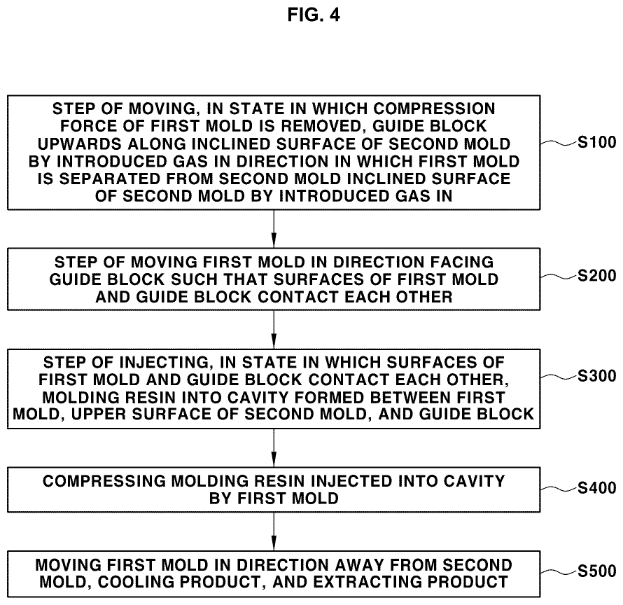

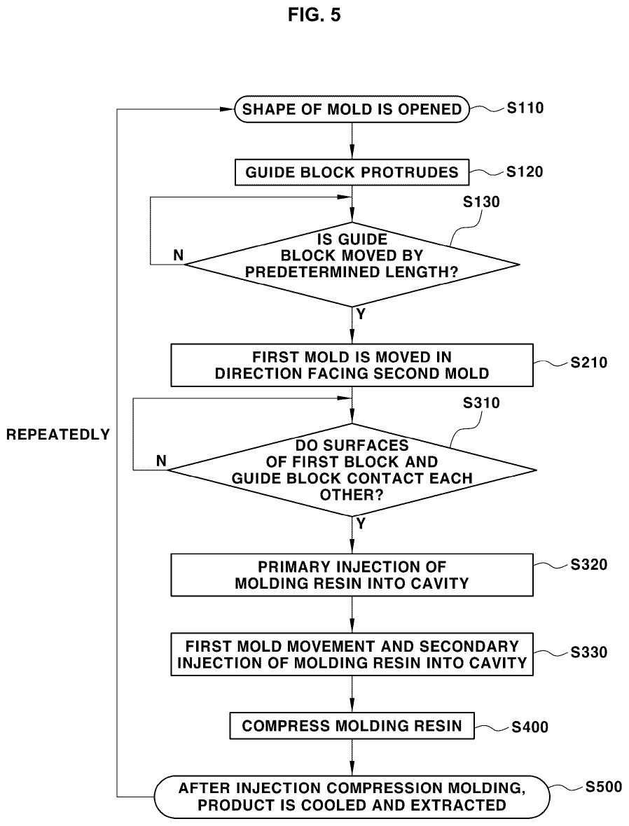

FIGS. 4 and 5 are flowcharts of an injection compression molding step according to the embodiment of the present disclosure.

According to the embodiment of the present disclosure, the injection compression molding step includes the following steps.

First, in a state in which the first mold 100 and the second mold 200 are separated from each other, the guide block 310 is moved upwards along the inclined surface of the second mold 200 by gas pressure inside the housing 322 in a direction in which the first mold 100 is separated from the second mold (S100). Preferably, the first mold 100 is moved upwards, the shape of the mold is opened, and the guide block 310 protrudes upwards in a state in which compression force is removed from the first mold 100 (S110 and S120).

When the guide block 310 is moved upwards by the guide bar 321, the controller 500 performs a process of determining, using a position sensor, whether the guide block 310 has been moved upwards by a length stored in the controller 500.

In this case, the position sensor transmits the real-time position of the guide block 310 to the controller 500. Preferably, the position sensor may be comprised of an optical position sensor, a magnetic position sensor, and an encoder-based position sensor.

The optical position sensor detects a marker or a specific mark installed along a movement path of the guide block 310 to determine the position of the guide block 310. When the guide block 310 is moved upwards, the position sensor detects a change in the position of the marker and transmits corresponding position information to the controller 500. The controller 500 may determine whether the guide block 310 has been moved upwards by a predetermined length while referring to received position data.

The magnetic position sensor detects a magnet attached to the guide block 310 so as to determine the position of the guide block. When the guide block 310 is moved upwards, the position sensor recognizes a change in the position of the magnet and transmits a signal related to the change to the controller 500. The controller 500 may analyze the position data of the magnet to determine whether the guide block 310 has been moved upwards by a predetermined movement distance.

The encoder-based position sensor precisely measures movement of the guide bar 321. The encoder generates a pulse signal generated by linear movement of the guide bar 321, and the pulse signal is transmitted to the controller 500. Based on the pulse signal, the controller 500 accurately calculates a movement distance of guide block 310 and determines whether the guide block has been moved upwards by a predetermined length (S130).

Through this procedure, the controller 500 determines whether the guide block 310 has been moved upward by the predetermined length stored in the controller 500. When the guide block 310 has not been moved upwards by the predetermined length stored in the controller 500, the controller moves the guide block 310 upwards.

When the guide block 310 has been moved upwards by the predetermined length stored in the controller 500, the controller 500 lowers the first mold 100 in a direction facing the second mold 200 so as to close the cavity 400. The first mold 100 is moved downwards to face the guide block 310 (S200 and S210).

In this case, the controller 500 performs a process of determining whether the guide block 310 and the first mold 100 are in a surface-to-surface contact state by receiving, through a contact sensor, a surface contact state between the guide block 310 and the first mold 100. Preferably, the contact sensor may be formed of a contact-type contact sensor, a pressure detection sensor, and a proximity sensor (S300).

The contact-type contact sensor uses a method of directly detecting contact between the guide block 310 and the first mold 100. The contact-type contact sensor detects a current flow or a signal change when the upper surface of the guide block 310 and the lower surface of the first mold 100 are in close contact with each other, and transmits the change signal to the controller 500. The controller 500 may determine, based on these signal changes, whether the upper surface of the guide block 310 and the lower surface of the first mold 100 are in contact with each other.

The pressure detection sensor measures pressure generated when the guide block 310 and the first mold 100 are in contact with each other and determines a contact state therebetween. When the guide block 310 and the first mold 100 are in close contact with each other, the pressure detection sensor detects pressure equal to or higher than a predetermined level, converts the detected pressure into a signal, and transmits the signal to the controller 500. The controller 500 may check the contact state therebetween by comparing the transmitted pressure with a pressure value set in the controller 500.

The proximity sensor detects a distance between the guide block 310 and the first mold 100 in a non-contact manner. The proximity sensor generates a signal when the upper surface of the guide block 310 and the lower surface of the first mold 100 approach each other within a predetermined distance, and a proximity signal is transmitted to the controller 500. The controller 500 may determine whether the surfaces of the two parts are in contact with each other through this proximity signal (S310).

When the upper surface of the guide block 310 and the lower surface of the first mold 100 are not in contact with each other, the controller 500 moves the first mold 100 downwards again. Through this procedure, when the upper surface of the guide block 310 and the lower surface of the first mold 100 are in contact with each other, the controller 500 performs a step of primarily injecting a molding resin into the cavity 400 (S320).

In this case, the molding resin is injected into the cavity 400 by the amount of primary injection set in the controller 500. After the molding resin is primarily injected into the cavity 400, the controller 500 performs a step of secondarily injecting a molding resin into the cavity 400 while further lowering the first mold 100 (S330).

When the molding resin is completely injected into the cavity 400, the controller 500 lowers the first mold 100 to compress the molding resin injected into the cavity 400 (S400).

After compressing the molding resin for a predetermined period of time, the controller 500 cools the molding resin by introducing coolant into the first mold 100, the second mold 200, and the inside of the guide block 310. In this manner, a product is produced through a process of compressing and cooling the molding resin.

After a molding resin cooling process is completed, the controller 500 moves the first mold 100 upwards. When the first mold 100 is moved upwards, external force applied to the guide block 310 is removed, and the guide block 310 is moved upwards by internal pressure of the housing 322.

When the lower surface of the first mold 100 is separated from the upper surface of the guide block 310, the cavity 400 is opened. After the cavity 400 is opened, the finished product is extracted from the cavity 400 (S500).

After the finished product is extracted from the injection compression molding device 10, the controller 500 returns to the initial step and repeatedly performs a process of moving the guide block 310 upwards by the length set in the controller 500.

In summary, according to the present disclosure, the surface of the guide block 310 including the inclined surface 313 and the surface of the first mold 100 are in contact with each other, thereby preventing the second mold 200 from being thermally deformed by a high-temperature molding resin, and the inclined surface 313 has a predetermined gradient for easy assembly and processing.

As is apparent from the above description, the present disclosure may achieve the following effects by the configuration, combination, and use relationship described in the embodiments.

First, a height adjustment device is employed to enable horizontal joining of two molds, thereby preventing mold deformation caused by a high temperature that has occurred in the conventional vertical joining method. In this manner, it is possible to obtain an effect of stably maintaining the quality of a molded product.

Second, since the horizontal joining method of the present disclosure does not require a separate component, a mold structure is simplified, thereby having an effect of improving efficiency of a manufacturing process and reducing manufacturing costs.

Third, since a process of extracting the molded product is simplified, productivity is improved, and the process time is shortened, thereby having an effect of maximizing production efficiency.

The present disclosure has been described in detail with reference to preferred embodiments thereof, and the present disclosure may be used in various other combinations, modifications, and environments. That is, it will be appreciated by those skilled in the art that changes may be made in these embodiments without departing from the principles and spirit of the disclosure, the scope of which is defined in the appended claims and equivalents thereto. The embodiments describe the best mode to implement the technical idea of the present disclosure, and various changes required in specific application fields and uses of the present disclosure are also possible. Accordingly, the detailed description of the present disclosure is not intended to limit the present disclosure to the disclosed embodiments. Additionally, the scope of the appended claims should be construed as including other embodiments as well.

What is claimed is:

1. An injection compression molding device comprising:
a first mold configured to compress a molding resin;
a second mold facing the first mold; and
a height adjustment device located inside the second mold, the height adjustment device configured to open in a direction in which the first mold is separated from the second mold,
wherein at least a part of the height adjustment device is selectively joined to the first mold so as to form a cavity located between the first mold, the second mold, and the height adjustment device.

2. The injection molding device of claim 1, wherein the height adjustment device comprises an inclined surface.

3. The injection molding device of claim 2, wherein the inclined surface includes an outer surface that opens in the direction in which the first mold is separated from the second mold.

4. The injection compression molding device of claim 1, further comprising a hole formed in the second mold.

5. The injection compression molding device of claim 4, wherein the hole is configured to expand in the direction in which the first mold is separated from the second mold.

6. The injection compression molding device of claim 4, wherein the height adjustment device comprises:
at least one guide block located in the hole;
a guide part coupled to a lower end of the guide block, the guide part being configured to move the guide block upwards and downwards; and
a cooling hose coupled to the guide block, the cooling hose being adjacent to the guide part.

7. The injection compression molding device of claim 6, further comprising:
a stepped portion located on the second mold, the stepped portion facing the guide block; and
a protrusion located on the guide block, the protrusion extending horizontally relative to the stepped portion.

8. The injection compression molding device of claim 6, wherein the guide part comprises:
a guide bar coupled to the lower end of the guide block; and
a housing located at a lower end of the guide bar.

9. The injection compression molding device of claim 8, further comprising:
a guide support plate located at a lower end of the housing; and
a fixing bolt connecting the guide support plate to the housing,
wherein the housing comprises a fluid inlet configured to allow gas to be introduced therethrough.

10. An injection compression molding method comprising:
moving, by a controller, a guide block upwards along an inclined surface of a second mold by introducing gas in a direction in which the first mold is separated from the second mold;
moving, by the controller, the first mold in a direction facing the guide block such that a surface of the first mold and a surface of the guide block contact each other;
injecting, by the controller, a molding resin into a cavity formed between the first mold, the second mold, and the guide block;
compressing, by the controller, the molding resin injected into the cavity by the first mold; and
moving, by the controller, the first mold in a direction away from the second mold, cooling a product, and extracting the product.

11. The injection molding method of claim 10, wherein moving the guide block occurs in a state in which a compression force of the first mold is removed.

12. The injection molding method of claim 10, wherein the molding resin is injected into the cavity between the first mold and an upper surface of the second mold.

13. The injection molding method of claim 10, wherein moving the guide block is carried out in a state in which the surfaces of the first mold and the guide block contact each other.

14. The injection compression molding method of claim 10, wherein the upward movement of the guide block along the inclined surface of the second mold by the introduced gas in the state in which the compression force of the first mold is removed comprises:
receiving, by the controller, a position of the guide block from an input part and determining, by the controller, whether the guide block is moved by a predetermined length; and
moving, by the controller, the first mold in a direction toward the second mold when the guide block is moved by the predetermined length.

15. The injection compression molding method of claim 14, wherein the injection of the molding resin into the cavity formed when the surfaces of the first mold and the guide block contact each other comprises:
receiving, by the controller, whether the surfaces of the first mold and the guide block contact each other from the input part and determining, by the controller, whether the surfaces of the first mold and the guide block contact each other; and
injecting, by the controller, a part of the molding resin into the cavity when the surfaces of the first mold and the guide block contact each other.

16. The injection compression molding method of claim 15, wherein the compression of the molding resin injected into the cavity by the first mold comprises moving the first mold in the direction toward the second mold so as to return the guide part moving the guide block upwards to an original position thereof, injecting the remaining molding resin into the cavity, and compressing the molding resin.

17. The injection compression molding method of claim 16, wherein the movement of the first mold in the direction away from the second mold to cool and extract the product comprises cooling the product produced after the first mold compresses the molding resin, moving the first mold in the direction away from the second mold, and extracting the product.

18. A non-transitory computer readable medium containing program instructions executed by a processor, the computer readable medium comprising:
program instructions that move a guide block upwards along an inclined surface of a second mold by introducing gas in a direction in which the first mold is separated from the second mold;
program instructions that move the first mold in a direction facing the guide block such that a surface of the first mold and a surface of the guide block contact each other;
program instructions that inject a molding resin into a cavity formed between the first mold, the second mold, and the guide block;
program instructions that compress the molding resin injected into the cavity by the first mold; and
program instructions that move the first mold in a direction away from the second mold, cooling a product, and extracting the product.
